(19) United States
(12) Patent Application Publication
(10) Pub. No.: US 2003/0112122 A1
(43) Pub. Date: Jun. 19, 2003

(54) Universal residence and vehicle locking and opening system

(76) Inventor: Peter H. L. Hu, Vancouver (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/015,578

(22) Filed: Dec. 17, 2001

(51) Int. Cl. G05B 19/00; H04Q 1/00

(52) U.S. Cl. 340/5.64; 340/5.72

(57) ABSTRACT

This invention relates to a novel universal residence and vehicle locking and opening system. More particularly, this invention pertains to a novel system for enabling an operator to utilize one remote control to activate a residential deadbolt lock, a residential security alarm system, and an automobile locking and security alarm system. A universal locking and opening system comprising: (a) a radio frequency operated door locking mechanism; (b) a radio frequency operated automobile locking and opening mechanism; and (c) a remote radio frequency transmitter control which can be activated to lock or unlock the door locking mechanism or the automobile locking and opening mechanism.

### TECHNICAL FIELD

This invention relates to a novel universal residence and vehicle locking and opening system. More particularly, this invention pertains to a novel system for enabling an operator to utilize one remote control to activate a residential deadbolt lock, a residential security alarm system, and an automobile locking and security alarm system.

### BACKGROUND

General Motors, Ford, Mercedes, Toyota, Honda and a host of other automobile makers offer automobile models which have remotely controlled motor activatable door and trunk locking and opening systems and alarm arming systems. The systems are usually operated by a small lithium battery powered hand size remote control which transmits RF signals to receivers in the automobile. The door and trunk locks are operated by electric motors, solenoids or electronic bolt trip mechanisms.

Two and three way deadbolts for locking doors of residences and commercial buildings are known. The following patents are of interest:

| U.S. Pat. No. | Inventor | Issue Date |
|---|---|---|
| 5,938,248 | Vickers et al. | Aug. 17, 1999 |
| 5,911,763 | Quesada | Jun. 15, 1999 |
| 5,791,179 | Brask | Aug. 11, 1998 |
| 5,790,034 | Khoury | Aug. 4, 1998 |
| 5,524,942 | Fleming | Jun. 11, 1996 |
| 5,290,077 | Fleming | Mar. 1, 1994 |

In particular, Quesada discloses a three point door lock mechanism which provides for deadbolts to be inserted into the upper, lower and side door jambs.

Khoury discloses a retrofittable remote controlled door lock system wherein a motor is controlled by a receiver which receives signals from a remote control transmitter. The motor operates a deadbolt lock by means of a door module. Khoury also provides for a panic alarm which can be hooked up to a receiver.

It is not uncommon for persons who have parked their automobile in a public parking lot with many stores to later forget where they parked their automobile. There is no mechanism that as a memory aid enables an automobile parker to record the location of the parked automobile. There is also no mechanism which enables a user to open and lock both an automobile and a residence, and also activate security alarms.

### SUMMARY OF INVENTION

The invention is directed to a universal locking and opening system comprising: (a) a radio frequency operated door locking mechanism; (b) a radio frequency operated automobile locking and opening mechanism; and (c) a remote radio frequency transmitter control which can be activated to lock or unlock the door locking mechanism or the automobile locking and opening mechanism.

The remote radio frequency transmitter control can be equipped with a microchip, a display panel and data entry buttons and data can be entered in control by an operator. The door locking mechanism can be a two-way deadbolt or a three-way deadbolt.

The system can include a security alarm system which can be activated by the remote radio frequency transmitter control. The remote radio frequency transmitter control can include a door lock arming button, a door lock opening button, an automobile locking and security activation button, an automobile door opening button and a trunk opening button. The remote radio frequency transmitter control can also include a door security alarm activation button.

The door locking mechanism can include a radio frequency operated deadbolt activator motor and protector sleeves encircling rods of the deadbolt locking system.

The security alarm can include a door movement sensor, a radio frequency remote signal receiver and an alarm loudspeaker.

### BRIEF DESCRIPTION OF DRAWINGS

In drawings which illustrate specific embodiments of the invention, but which should not be construed as restricting the spirit or scope of the invention in any way:

FIG. 1 illustrates a schematic view of a universal locking and opening system for a door and an automobile.

FIG. 2 illustrates a detailed elevation of a three-way door deadbolt system activatable by remote control.

FIG. 3 illustrates an end section view of a deadbolt rod and a protecting circumferential sleeve.

FIG. 4 illustrates a detail elevation of a door security alarm system.

FIG. 5 illustrates a bottom view of a remote control.

### DETAILED DESCRIPTION OF THE INVENTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The invention relates to a multi-function remote controlled door locking and alarm system. The door is constructed so that it has a one-way deadbolt system (for retrofitting existing door systems) or a two-way or three-way deadbolt system. The door is also equipped with an alarm and warning light system. The deadbolt system is operated manually or electronically, in the same manner as a conventional electronic automobile locking system. The remote control system has on one side a set of buttons which using a first custom designated RF frequency activate and deactivate the locking system of an automobile. On the opposite side is a set of buttons that by using a second custom designated RF frequency remotely activate and deactivate the two-way or three-way deadbolt door. The remote control also includes data entry buttons and a computer memory chip system which enable the operator to record in the remote control certain memory-aid information such as the location where the operator last parked his or her automobile.

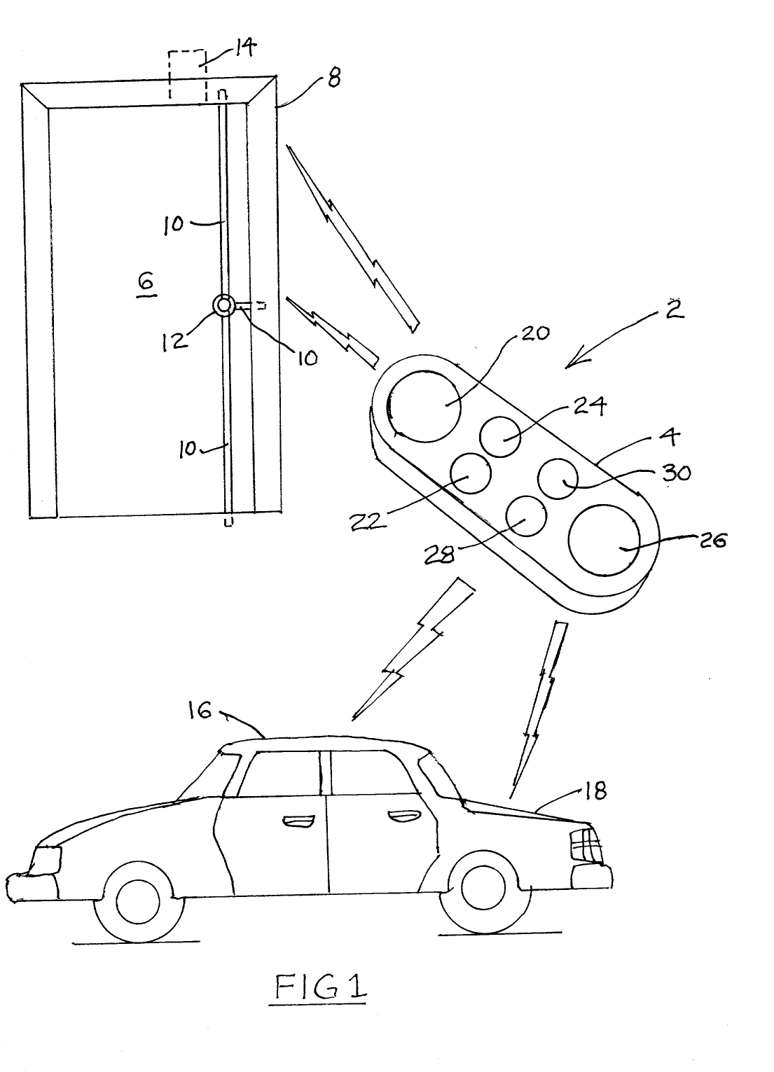

FIG. 1 illustrates a schematic view of multi-function remote control system for locking and unlocking a door lock and/or an automobile and/or setting a security alarm. The system comprises a strong three-bolt lock with the bolt penetrating the top, bottom, and side door frame of the door 6 opposite of the hinges of the door. The opening and closing of the lock is controlled by an activator 12 that has a receiver to receive signals from a remote control transmitter 4. The transmitter 4 can also optionally activate a security alarm system 14. The door can be equipped with a movement sensor.

More specifically, as seen in FIG. 1, the universal locking and opening system 2 comprises manually operated remote control 4, a door 6 and a door frame 8, the door 6 being equipped with a three-way deadbolt 10. The three-way deadbolt 10 is operated by a three-way deadbolt signal receiver and activator 12. A security alarm box 14 is positioned above the door 6 and proximate to the top of the door frame 8.

FIG. 1 also illustrates an automobile 16, with trunk 18, both being equipped with and capable of being locked or opened by a remote control, according to existing technology. The remote control 4, as shown in FIG. 1, is equipped with a door lock arming button 20, a door lock opening button 22, a door security alarm activation button 24, an automobile locking and security activation button 26, an automobile door opening button 28 and a trunk opening button 30.

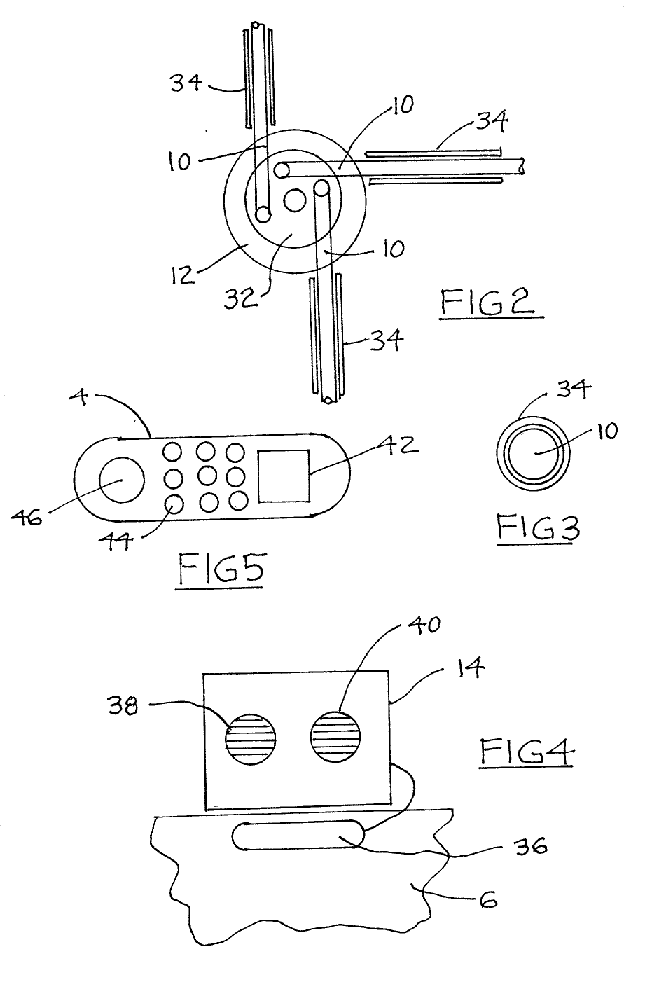

FIG. 2 illustrates a detailed elevation view of the three-way deadbolt signal receiver and activator 12. The activator 12 includes a motor 32 which rotates clockwise or counterclockwise approximately 15 to 20 degrees in order to reciprocally move the three right angle disposed deadbolt rods 10 into respective locking or unlocking positions in the door frame 8. As seen in FIG. 1, for instance, the three-way deadbolt 10 is shown with the rods protruding into the top door frame 8, the side door frame 8 and the floor in a locked manner. To open the door, the operator manipulates the remote control 4, which sends an RF signal which activates the motor 32. The motor 32 rotates counterclockwise and retracts the three deadbolt rods 10 into an unlocked position. FIG. 2 also illustrates three respective deadbolt rod protection sleeves 34, which guide the respective rods 10 and permit the rods to move freely from a locked position to an unlocked position and vice versa. The sleeves protect the bolt rods 10 and prevent them from jamming.

FIG. 3 shows an end section view of a deadbolt rod 10 and the encircling protection sleeve 34. The deadbolt rod 10 is typically constructed of hardened steel. The protecting sleeves 34 can be a suitable metal or plastic.

FIG. 4 shows a detailed elevation view of the security alarm box 14 mounted above the door 6 (see FIG. 1 for orientation). The security alarm box 14 is electrically connected to a door movement sensor 36 which is secured to the top region of the door. It will be understood that the door movement sensor 36, if equipped with a small radio transmitter, can communicate in a wireless RF manner with the electronic components of the security alarm box 14, according to existing technology. The security alarm box 14 is equipped with a remote signal receiver 38, which is receptive to RF signals emitted by the remote control 4 when it is manually activated. When an RF signal of a specific frequency is sent from the remote control 4 by the operator pressing the door security alarm activation button 24, the RF signal is received by the remote signal receiver 38, and the security alarm system is activated. The security alarm system 14 can be disarmed by the operator pressing an appropriate disarm button on the remote control 4. The security alarm box 14 also includes an alarm loudspeaker 40, which is adapted to emit a loud alarm signal when an intruder attempts to open the door 6, which in turn activates the door movement sensor 36.

FIG. 5 illustrates a bottom view of the remote control 4. As seen in FIG. 5, the bottom of the remote control 4 is equipped with a liquid crystal display panel 42 and a series of data entry buttons 44. The bottom of the remote control 4 also includes a data clear button 46. If need be, one of the buttons can be a data “enter” button which serves to ensure that the data punched into the buttons 44 by the operator enter a battery powered computer chip which is mounted inside the remote control 4, according to existing technology. The liquid crystal display panel 42 displays data entered by the operator on the data entry buttons 44.

The purpose of the liquid crystal display 42 and the data entry buttons 44 is to enable the operator to punch in information such as the location at which the automobile 16 has been parked, for example, in a commercial parking lot. It is not uncommon for automobile drivers, after they have parked the automobile in a commercial parking lot, on a certain parking level, to forget at a later time where they parked the automobile. They are then faced with having to search for their automobile, which often can be a frustration. The data entry buttons 44 and the liquid crystal display panel 42 enable the operator to key in the appropriate information about the parking location of the automobile. The information can be readily cleared at any time by pressing the data clear button 46.

As will be apparent to those skilled in the art in the light of the foregoing disclosure, many alterations and modifications are possible in the practice of this invention without departing from the spirit or scope thereof. For instance, while a three-way deadbolt system has been illustrated and discussed, it is understood that the invention also applies to one-way and two-way deadbolt systems. It will also be understood that the remote control can have all the data entry buttons on one side, and the display panel can also be on the same side as the data entry buttons. Accordingly, the scope of the invention is to be construed in accordance with the substance defined by the following claims.

What is claimed is:

1. A universal locking and opening system comprising:
(a) a radio frequency operated door locking mechanism;
(b) a radio frequency operated automobile locking and opening mechanism; and
(c) a remote radio frequency transmitter control which can be activated to lock or unlock the door locking mechanism or the automobile locking and opening mechanism.

2. A system as claimed in claim 1 wherein the remote radio frequency transmitter control is equipped with a microchip, a display panel and data entry buttons and data can be entered in the control by an operator.

3. A system as claimed in claim 1 wherein the door locking mechanism is a one-way or a two-way deadbolt.

4. A system as claimed in claim 1 wherein the door locking mechanism is a three-way deadbolt.

5. A system as claimed in claim 1 including a security alarm system which can be activated by the remote radio frequency transmitter control.

6. A system as claimed in claim 1 wherein the remote radio frequency transmitter control includes a door lock arming button, a door lock opening button, an automobile locking and security activation button, an automobile door opening button and a trunk opening button.

7. A system as claimed in claim 6 wherein the remote radio frequency transmitter control includes a door security alarm activation button.

8. A system as claimed in claim 1 wherein the door locking mechanism includes a radio frequency operated deadbolt activator motor.

9. A system as claimed in claim 8 wherein the door locking mechanism includes protector sleeves encircling rods of the deadbolt locking system.

10. A system as claimed in claim 5 wherein the security alarm includes a door movement sensor, a radio frequency remote signal receiver and an alarm loud-speaker.
